(19) United States
(12) Patent Application Publication
(10) Pub. No.: US 2021/0279386 A1
(43) Pub. Date: Sep. 9, 2021

(54) MULTI-MODAL DEEP LEARNING BASED SURROGATE MODEL FOR HIGH-FIDELITY SIMULATION

(71) Applicant: International Business Machines Corporation, Armonk, NY (US)

(72) Inventors: Xiaoxiao Guo, Mountain View, CA (US); Xin Zhang, Chappaqua, NY (US); Mo Yu, White Plains, NY (US)

(21) Appl. No.: 16/810,687

(22) Filed: Mar. 5, 2020

(51) Int. Cl. G06F 30/27; G06F 30/28

(52) U.S. Cl. CPC G06F 30/27; G06F 2111/04; G06F 30/28

(57) ABSTRACT

A method of using multiple artificial intelligence models for generating a high fidelity simulation includes generating, by a computing device, multiple artificial intelligence models. Each artificial intelligence model simulating an industry design process. The computing device further fusing the multiple artificial intelligence models to generate a best-fit proposed industry design process. The computing device utilizes a physics constraint model to determine whether the best-fit proposed industry design process is feasible. The best-fit proposed industry design process is displayed in response to determining that the best-fit proposed industry design process is feasible.

### BACKGROUND

The field of embodiments of the present invention relates to multi-modal deep learning (DL)-based surrogate models for high-fidelity simulation.

High-fidelity simulation is widely applied and crucial in various industry design processes in technology fields, such as magnetic fields, fluid dynamics, heat diffusion, etc. Traditional simulation methods built on a Finite Element Method (FEM) are computationally expansive and time-consuming. Researchers and engineers turn to computationally cheaper surrogate models in balancing the accuracy and cost.

One key limit of previous work is that existing DL-based surrogate models for high-fidelity simulations only consider a single design scope (e.g., geometry, layout, boundary condition, etc.).

### SUMMARY

Embodiments relate to multi-modal deep learning (DL)-based surrogate models for high-fidelity simulation. One embodiment provides a method of using multiple artificial intelligence (AI) models for generating a high fidelity simulation includes generating, by a computing device, multiple AI models. Each AI model simulating an industry design process. The computing device further fusing the multiple AI models to generate a best-fit proposed industry design process. The computing device utilizes a physics constraint model to determine whether the best-fit proposed industry design process is feasible. The best-fit proposed industry design process is displayed in response to determining that the best-fit proposed industry design process is feasible. These features contribute to the advantage of DL-based surrogate models for multiple design scopes required in practical design tasks. The features further contribute to the advantage of representing multiple design scopes in a coherent representation for prediction. The features still further contribute to the advantage of combining machine learning (ML) based fusion components and physics-aware fusion constraints and objectives.

One or more of the following features may be included. In some embodiments, the high fidelity simulation is selectively used for one of: a magnetic field, fluid dynamics, or heat diffusion, and the fusing includes aggregating information from different design scopes via concatenation, gating, pooling, averaging, or tensor-based approximation.

In some embodiments, the physics constraint model introduces constraints including non-AI constraints or non-machine learning constraints. The constraints include encoding constraints, fusion constraints and decoding constraints.

In some embodiments, the encoding constraints include: a reconstruction objective, a classification objective or a regression objective of physical quantities of inputs.

In some embodiments, the encoding constraints include: a reconstruction objective, a classification objective or a regression objective of a physical relationship among different physical quantities of inputs.

In some embodiments, the fusion constraints comprise restricted fusion processes that satisfy a physical relationship or interaction among different inputs.

In some embodiments, the fusion constraints include a reconstruction objective, classification objective or regression objective of physical relationships among a sub-group of inputs.

In some embodiments, the decoding constraints include a classification objective or a regression objective of physical quantities of output.

In some embodiments, the decoding constraints comprise a reconstruction objective, a classification objective or a regression objective of a physical relationship among different physical quantities of output.

In some embodiments, the physical relationship is a hypothesis.

These and other features, aspects and advantages of the present embodiments will become understood with reference to the following description, appended claims and accompanying figures.

### BRIEF DESCRIPTION OF THE DRAWINGS

FIG. 1 depicts a cloud computing environment, according to an embodiment;

FIG. 2 depicts a set of abstraction model layers, according to an embodiment;

FIG. 3 is a network architecture of a system for multi-modal deep learning (DL)-based surrogate model for high-fidelity simulation processing, according to an embodiment;

FIG. 4 shows a representative hardware environment that may be associated with the servers and/or clients of FIG. 1, according to an embodiment;

FIG. 5 is a block diagram illustrating a distributed system for multi-modal DL-based surrogate model for high-fidelity simulation processing, according to one embodiment;

FIG. 6 is an example of a block diagram of DL-based surrogate models;

FIG. 7 is a block diagram of an example multi-modal DL for high-fidelity simulation surrogate modeling, according to one embodiment;

FIG. 8 is a block diagram of a multi-modal fusion component, according to one embodiment; and

FIG. 9 illustrates a block diagram of a process for using multiple artificial intelligence (AI) models for generating a high fidelity simulation, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to multi-modal deep learning (DL)-based surrogate models for high-fidelity simulation. One embodiment provides a method of using multiple artificial intelligence (AI) models for generating a high fidelity simulation includes generating, by a computing device, multiple AI models. Each AI model simulating an industry design process. The computing device further fusing the multiple AI models to generate a best-fit proposed industry design process. The computing device utilizes a physics constraint model to determine whether the best-fit proposed industry design process is feasible. The best-fit proposed industry design process is displayed in response to determining that the best-fit proposed industry design process is feasible. Other embodiments include a computer program product for using multiple artificial intelligence models for generating a high fidelity simulation, and an apparatus including a memory for storing instructions and a processor configured to execute the instructions. The method may further include that the high fidelity simulation is selectively used for one of: a magnetic field, fluid dynamics, or heat diffusion, and the fusing includes aggregating information from different design scopes via concatenation, gating, pooling, averaging, or tensor-based approximation. The method may additionally include that the physics constraint model introduces constraints including non-AI constraints or non-machine learning (ML) constraints. The constraints include encoding constraints, fusion constraints and decoding constraints. The method may still further include that the encoding constraints include: a reconstruction objective, a classification objective or a regression objective of physical quantities of inputs. The method may additionally include that the encoding constraints include: a reconstruction objective, a classification objective or a regression objective of a physical relationship among different physical quantities of inputs. The method may still further include the fusion constraints comprise restricted fusion processes that satisfy a physical relationship or interaction among different inputs. The method may still further include that the fusion constraints include a reconstruction objective, classification objective or regression objective of physical relationships among a sub-group of inputs. The method may additionally include that the decoding constraints include a classification objective or a regression objective of physical quantities of output. The method may further include that the decoding constraints comprise a reconstruction objective, a classification objective or a regression objective of a physical relationship among different physical quantities of output. The method may still further include that the physical relationship is a hypothesis.

A surrogate model is an engineering method that is used when an outcome of interest cannot be easily directly measured. Therefore, a model of the outcome is used. Many engineering design problems require experiments, simulations, or both to evaluate a design objective and constraint functions as a function of design variables. For many real-world problems, a single simulation can take many minutes, hours, or even days to complete processing. As a result, routine tasks such as design optimization, design space exploration, sensitivity analysis, etc., become impossible as there can be a multitude of simulation evaluations. Construction of approximation models, referred to as surrogate models, simulate the behavior of the simulation model as closely as possible and are computationally less expensive to evaluate. Surrogate models are typically constructed using a data-driven, bottom-up approach. The inner working of the simulation code is not assumed to be known as the input-output behavior is more important. A model may be constructed based on modeling the response of the simulator to a limited number of intelligently chosen data points. When only a single design variable is involved, the process is known as curve fitting.

AI models may include a trained ML model (e.g., models, such as a neural network (NN), a convolutional NN (CNN), a deep NN (DNN), a recurrent NN (RNN), a Long short-term memory (LSTM) based NN, gate recurrent unit (GRU) based RNN, tree-based CNN, self-attention network (e.g., an NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes.

It is understood in advance that although this disclosure includes a detailed description of cloud computing, implementation of the teachings recited herein are not limited to a cloud computing environment. Rather, embodiments of the present embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

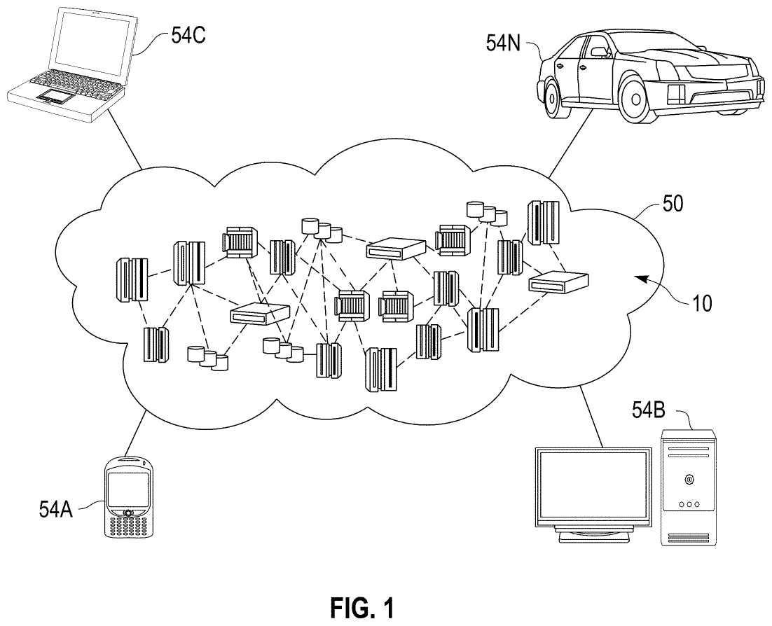

Referring now to FIG. 1, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

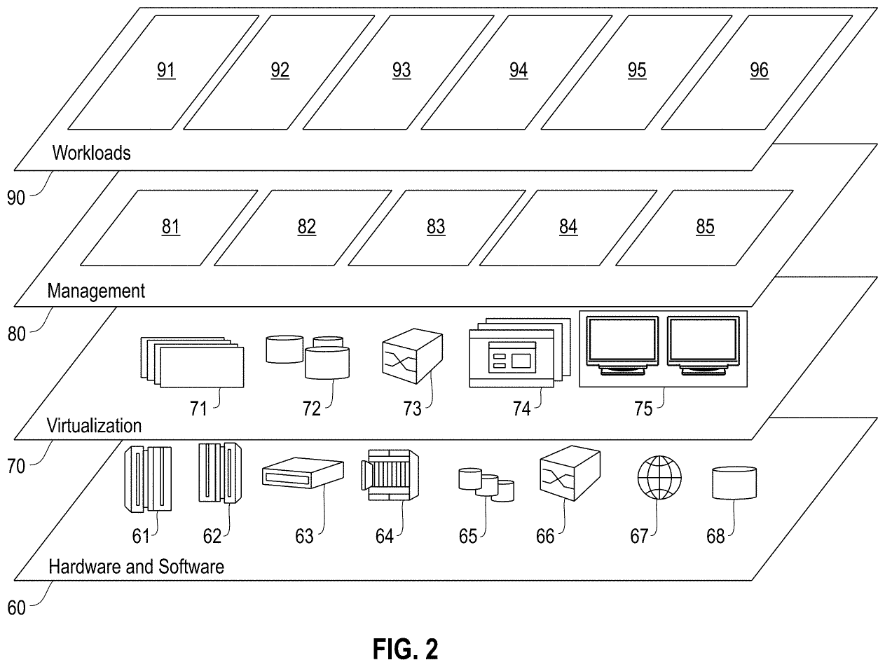

Referring now to FIG. 2, a set of functional abstraction layers provided by the cloud computing environment 50 (FIG. 1) is shown. It should be understood in advance that the components, layers, and functions shown in FIG. 2 are intended to be illustrative only and embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, a management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

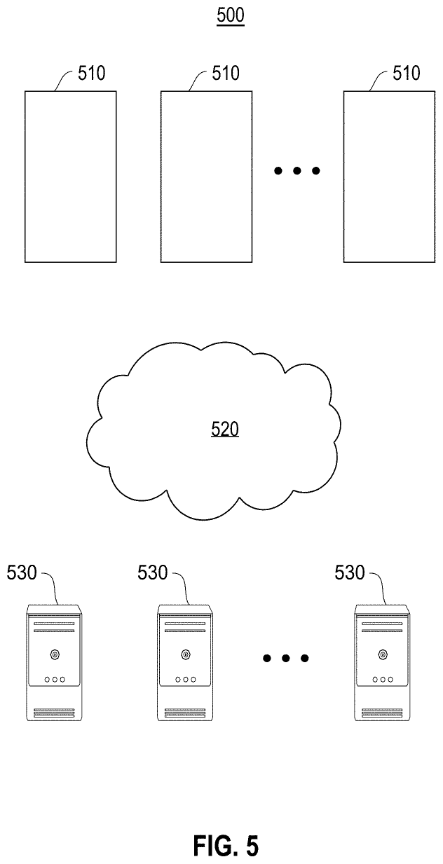

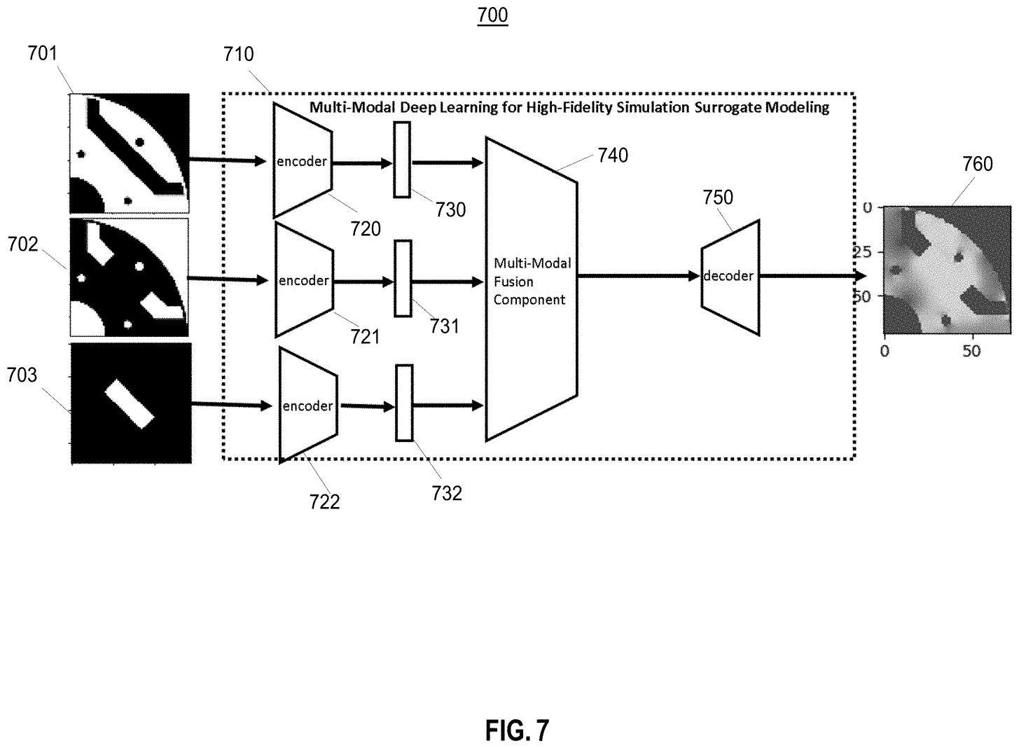

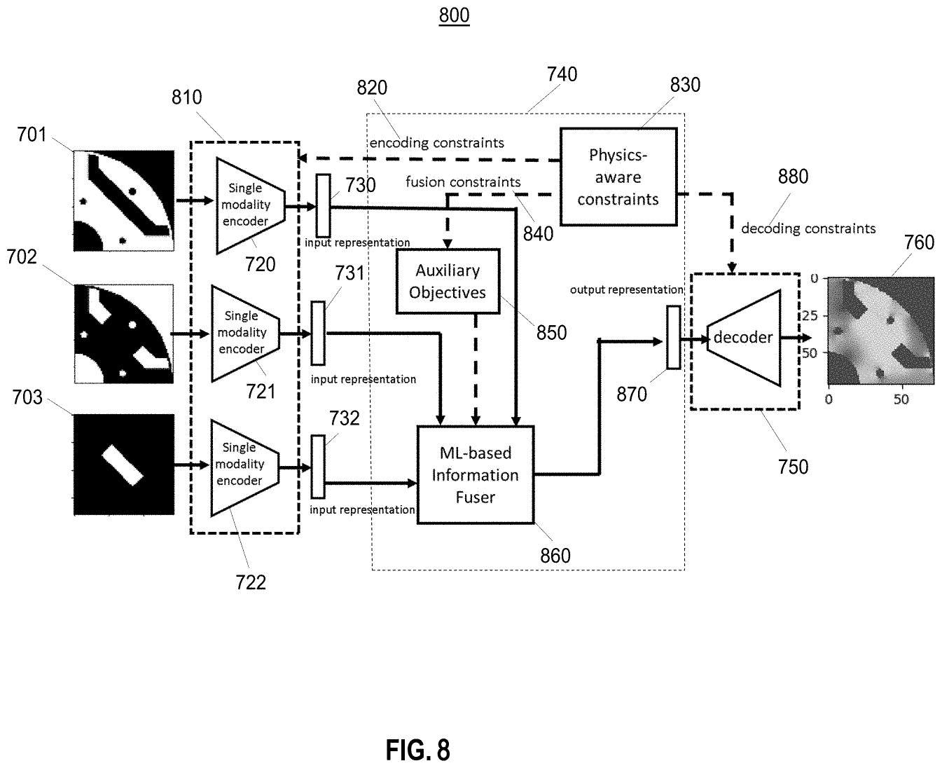

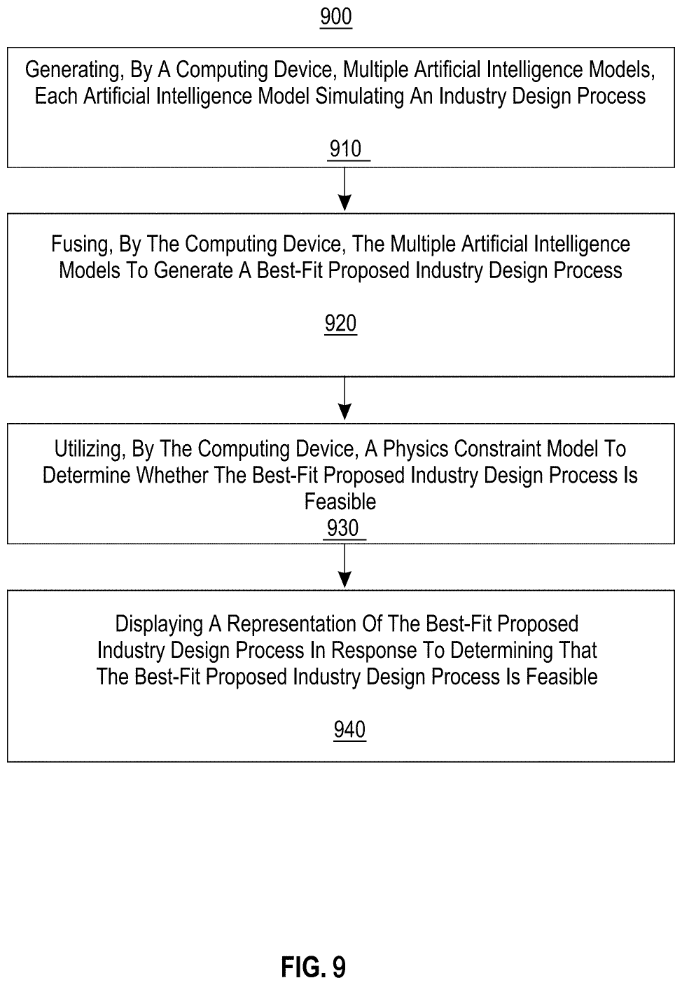

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and for multi-modal DL-based surrogate models for high-fidelity simulation processing 96 (see, e.g., system 500, FIG. 5, block diagram 700, FIG. 7, block diagram 800, FIG. 8, and process 900, FIG. 9). As mentioned above, all of the foregoing examples described with respect to FIG. 2 are illustrative only, and the embodiments are not limited to these examples.

It is reiterated that although this disclosure includes a detailed description on cloud computing, implementation of the teachings recited herein are not limited to a cloud computing environment. Rather, the embodiments may be implemented with any type of clustered computing environment now known or later developed.

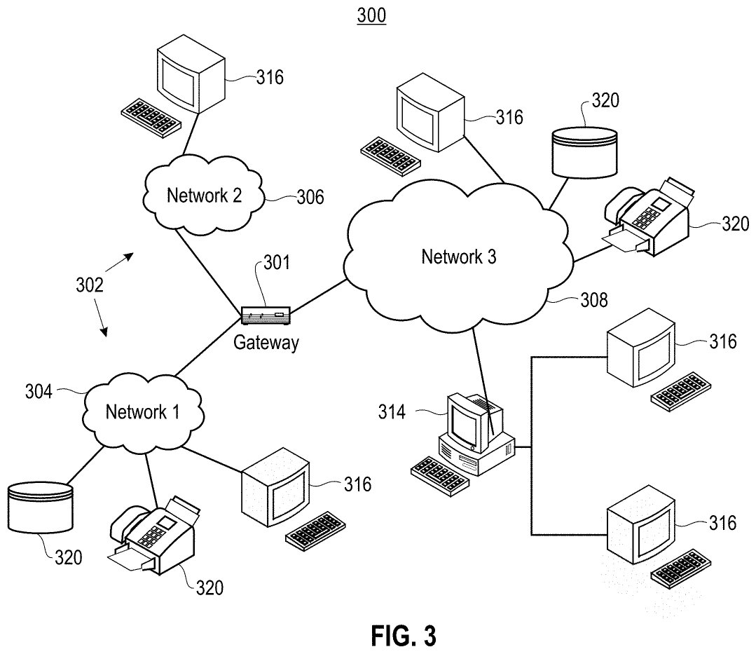

FIG. 3 is a network architecture of a system 300 for multi-modal DL-based surrogate models for high-fidelity simulation processing, according to an embodiment. As shown in FIG. 3, a plurality of remote networks 302 are provided, including a first remote network 304 and a second remote network 306. A gateway 301 may be coupled between the remote networks 302 and a proximate network 308. In the context of the present network architecture 300, the networks 304, 306 may each take any form including, but not limited to, a LAN, a WAN, such as the Internet, public switched telephone network (PSTN), internal telephone network, etc.

In use, the gateway 301 serves as an entrance point from the remote networks 302 to the proximate network 308. As such, the gateway 301 may function as a router, which is capable of directing a given packet of data that arrives at the gateway 301, and a switch, which furnishes the actual path in and out of the gateway 301 for a given packet.

Further included is at least one data server 314 coupled to the proximate network 308, which is accessible from the remote networks 302 via the gateway 301. It should be noted that the data server(s) 314 may include any type of computing device/groupware. Coupled to each data server 314 is a plurality of user devices 316. Such user devices 316 may include a desktop computer, laptop computer, handheld computer, printer, and/or any other type of logic-containing device. It should be noted that a user device 316 may also be directly coupled to any of the networks in some embodiments.

A peripheral 320 or series of peripherals 320, e.g., facsimile machines, printers, scanners, hard disk drives, networked and/or local storage units or systems, etc., may be coupled to one or more of the networks 304, 306, 308. It should be noted that databases and/or additional components may be utilized with, or integrated into, any type of network element coupled to the networks 304, 306, 308. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WINDOWS® environment, a MICROSOFT® WINDOWS® system that emulates an IBM® z/OS environment, etc. This virtualization and/or emulation may be implemented through the use of VMWARE® software in some embodiments.

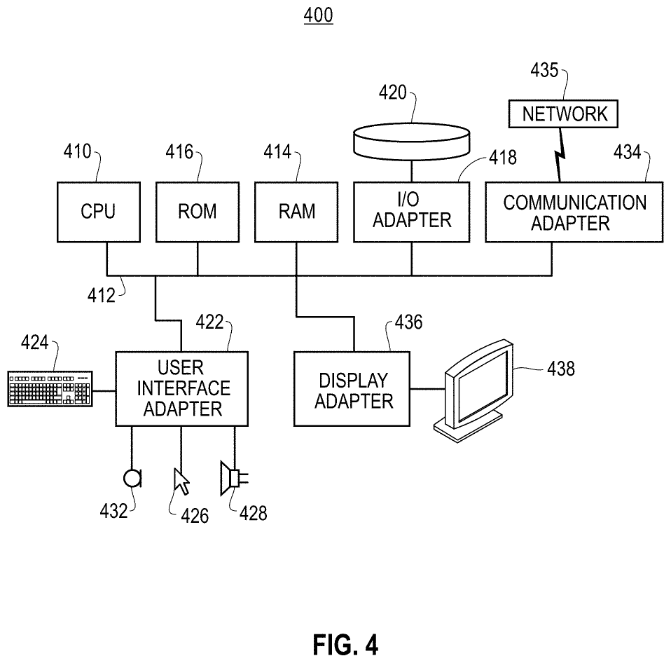

FIG. 4 shows a representative hardware system 400 environment associated with a user device 316 and/or server 314 of FIG. 3, in accordance with one embodiment. In one example, a hardware configuration includes a workstation having a central processing unit 410, such as a microprocessor, and a number of other units interconnected via a system bus 412. The workstation shown in FIG. 4 may include a Random Access Memory (RAM) 414, Read Only Memory (ROM) 416, an I/O adapter 418 for connecting peripheral devices, such as disk storage units 420 to the bus 412, a user interface adapter 422 for connecting a keyboard 424, a mouse 426, a speaker 428, a microphone 432, and/or other user interface devices, such as a touch screen, a digital camera (not shown), etc., to the bus 412, communication adapter 434 for connecting the workstation to a communication network 435 (e.g., a data processing network) and a display adapter 436 for connecting the bus 412 to a display device 438.

In one example, the workstation may have resident thereon an operating system, such as the MICROSOFT® WINDOWS® Operating System (OS), a MAC OS®, a UNIX® OS, etc. In one embodiment, the system 400 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

FIG. 5 is a block diagram illustrating a distributed system 500 for multi-modal DL-based surrogate models for high-fidelity simulation processing, according to one embodiment. In one embodiment, the system 500 includes client devices 510 (e.g., mobile devices, smart devices, computing systems, etc.), a cloud or resource sharing environment 520 (e.g., a public cloud computing environment, a private cloud computing environment, a data center, etc.), and servers 530. In one embodiment, the client devices 510 are provided with cloud services from the servers 530 through the cloud or resource sharing environment 520.

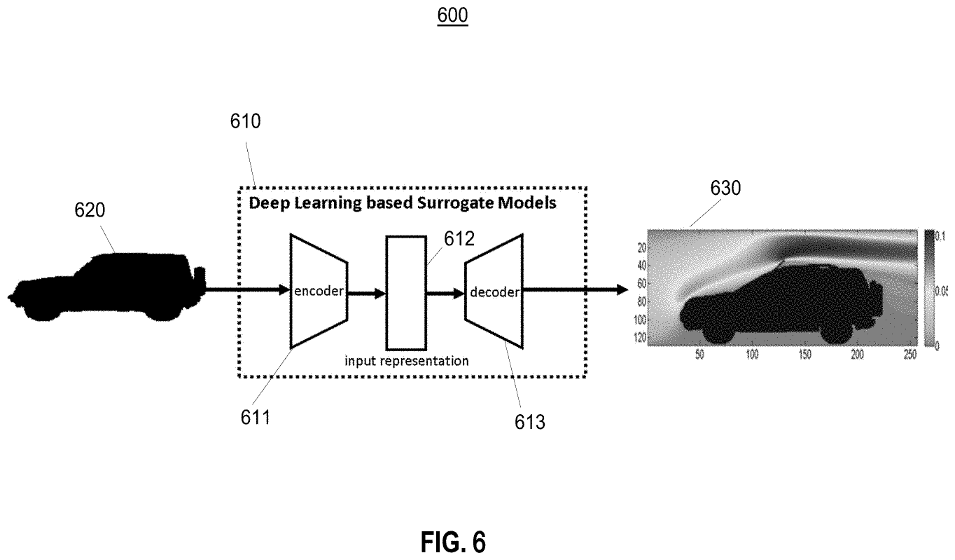

FIG. 6 is an example of a block diagram 600 for DL-based surrogate models 610. The block diagram 600 represents DL-based surrogate models 610 for fluid dynamics for a vehicle 620. The vehicle 620 represents an object geometry boundary (or its signed distance function). The DL-based surrogate models 610 includes an encoder 611, input representation 612 and decoder 613. The output information 630 represents a computational air dynamics field. The encoder 611 is a network (e.g., NN, CNN, RNN, etc.) that takes the input from the vehicle 620, and outputs a feature map/vector/tensor (used as the input representation 612 to the decoder 613). The feature vector holds the information (the features) that represents the input (input representation 612). The decoder 613 is a network (typically the same network structure as the encoder 611, but in an opposite orientation) that takes the feature vector (input representation 612) from the encoder 611, and gives the best closest match to the actual input or intended output (output information 630). The encoder 611 is trained with the decoder 613. A loss function is based on computing the difference between the actual and predicted output. An optimizer (not shown) of the DL-based surrogate models 610 attempts to train both the encoder 611 and the decoder 613 to lower the prediction loss. Once trained, the encoder 611 provides the feature vector for the input representation 612 that can be use by the decoder 613 to predict the output (from the vehicle 630) with the features (that matter the most) to make the predicted output (input representation 612) recognizable as the actual output. In applications, the intent is not to reconstruct the actual input, but rather to map/translate/associate inputs to certain outputs.

FIG. 7 is a block diagram 700 of an example for a multi-modal DL for high-fidelity simulation surrogate modeling 710, according to one embodiment. Multiple design scopes are required in practical design tasks. For example, for an inductor of a power converter, multiple materials and configurations need to be considered. Multiple design scopes lead to challenges, such as how to represent multiple design scopes in a coherent representation for prediction. In the block diagram 700, the input includes input 701 (e.g., a steel mass distribution map, etc.), input 702 (e.g., a non-magnetic mass distribution map, etc.) and input 703 (e.g., a magnetic rotor, etc.). The multi-modal DL for high-fidelity simulation surrogate modeling 710 includes multiple (single modality) encoders (e.g., encoder 720, encoder 721 and encoder 722) associated with the corresponding inputs (input 701, input 702 and input 703). Distinguishable from the DL-based surrogate models 610, which deals with a single design scope, the multi-modal DL for high-fidelity simulation surrogate modeling 710 takes the input representations (input representation 730, input representation 731 and input representation 732) from multiple encoders (encoder 720, encoder 721 and encoder 722) as input to a multi-modal ML-based fusion component 740 (including physics-aware constraints 830 component (or model), an auxiliary objectives component 850 and an ML-based information fuser component 860, which are further described below, (FIG. 8)). The output representation 870 (FIG. 8) of the multi-modal ML-based fusion component 740 along with decoding constraints 880 (FIG. 8) are the input for the decoder 750.

In one embodiment, the encoders 720, 721 and 722, and the decoder 750 are networks (e.g., NN, CNN, RNN, etc.). The encoders 720, 721 and 722 take the input from the inputs 701, 702 and 703, and output feature maps/vectors/tensors (used as the input representations 730, 731 and 732 to the multi-modal ML-based fusion component 740. The feature vectors hold the information (the features) that represents the input (input representations 730, 731 and 732). The decoder 750 takes the feature vectors (input representations 730, 731 and 732) from the encoders 720, 721 and 722, and gives the best closest match to the actual input or intended output (output or display information 760 (e.g., computational magnetic field, etc.)), which may be displayed on a display device (e.g., the display device 438, etc.), printed out from a printer, etc. The encoders 720, 721 and 722 are trained with the decoder 750 and the multi-modal fusion component 860. It should be noted that while block diagram 700 shows three inputs (inputs 701, 702 and 703) and encoders (encoders 720, 721 and 722), the multi-modal DL for high-fidelity simulation surrogate modeling 710 may have two or more (e.g., four, five, etc.) multi-modality based systems with additional inputs and encoders.

FIG. 8 is a block diagram 800 showing further details of a multi-modal ML-based fusion component 740, according to one embodiment. In one embodiment, the multi-modal ML-based fusion component 740 includes the physics-aware constraints component 830, the auxiliary objectives component 850 and the ML-based information fuser component 860. The multi-modal ML-based fusion component 740 provides for combining ML-based fusion components from the ML-based information fuser component 860, (physics-aware) fusion constraints 840 from the physics-aware constraints component 830 and auxiliary objectives from the auxiliary objectives component 850. In one embodiment, the physics-aware constraints component 830 provides encoding constraints 820 to the encoder block 810 (including the encoders (single modality encoders) 720, 721 and 722), the fusion constraints 840 to the auxiliary objectives component 850 and decoding constraints 880 to the decoder 750. In one embodiment, the (multi-modal) ML-based information fuser component 860 aggregates information from different design scopes via concatenation, gating, pooling, averaging, tensor-based approximation mechanisms, etc. In one embodiment, the physics-aware constraints component 830 poses extra non-ML constraints including the encoding constraints 820, auxiliary objectives information (fusion (or fuser) constraints 840) for the ML-based information fuser 860 and the decoding constraints 880. In one embodiment, the constraints may be specified by experts or previously extracted from experimental data.

In one embodiment, the encoding constraints 820 may include a reconstruction objective or classification/regression objective of physical quantities of inputs. In one embodiment, the encoding constraints 820 may include the reconstruction objective or classification/regression objective of the physical relationship among different physical quantities of the inputs. In one example embodiment, in the block diagram 700 of FIG. 7, the reconstruction objective may be to minimize the mass distribution difference between the original input and reconstructed mass distribution (701, 702). The electromagnetic field of the magnetic materials (701) should be within the mass distribution of the magnetic materials (701). The electromagnetic field of the non-magnetic materials (702) should be constantly zero within the mass distribution of the non-magnetic materials (702).

In one embodiment, the fusion constraints 840 may be restricted fusion mechanisms that satisfy the physical relationship/interaction among different inputs. In one embodiment, the fusion constraints 840 may include the reconstruction objective or classification/regression objective of physical relationships among a sub-group of inputs. In one example embodiment, in the block diagram 700 of FIG. 7, the mass distribution of magnetic materials (701) and non-magnetic materials (702) are exclusive, and the boundary of the magnetic motor (703) should not be within the boundary of the non-magnetic materials (702).

In one embodiment, the decoding constraints 880 may include one or more classification/regression objectives of physical quantities of the output. In one embodiment, the decoding constraints 880 may include one or more reconstruction objectives or classification/regression objectives of the physical relationship among different physical quantities of the output. In one example embodiment, in the block diagram 700 of FIG. 7, the distribution of the predicted electromagnetic field (760) should be spatially continuous, and the distribution of the predicted electromagnetic field (760) should be within the boundary of the magnetic materials (701) and the magnetic motor (703).

In one embodiment, given the input representations (x1, x2, x3 for 730, 731, 732), the ML-based information fuser 860 generates the output representation (h) by combining these input representations via concatenation (h=x1⊗x2⊗x3), gating (h=σ(x2)⊗x1+σ(x2)⊗x3, where ⊗ is an element-wise product and σ ( ) is the sigmoid function), pooling (h=elementwise-max(x1,x2,x3)), averaging (h=(x1+x2+x3)/3), a tensor based approximation mechanism (e.g., approximating h=M⊙x1⊙x2⊙x3, where ⊙ denotes a tensor mode product). In one embodiment, the fusion constraints 840 comprise restricted fusion processes that satisfy a physical relationship or interaction among different inputs (e.g., the fusion process provides how x1,x2,x3 are processed to generate the output representation h, for example, h=(σ(x2)⊗x1)⊗x3 is another fusion process that x1 and x2 are first gated and then the intermediate output is concatenated with x3). Additional fusion constraints 840 apply auxiliary objectives 850 on the fusion process by restricting the transformation of input representations to the output representation (generally, the fusion constraints 840 are a set of functions (C1, C2, etc.) that measure the degree of satisfaction of the output representation h. For example, the reconstruction of x1 could be a function C1(x1, h), and the relationship between different physic quantities could be C2(x1,x2,x3, h). In one embodiment, the function of the auxiliary objectives 850 is to maximize C1(x1, h)+C2(x1, x2, x3, h)).

FIG. 9 illustrates a block diagram of a process 900 of using multiple AI models for generating a high fidelity simulation, according to one embodiment. In one embodiment, in block 910 process 900 utilizes a computing device (from computing node 10, FIG. 1, hardware and software layer 60, FIG. 2, processing system 300, FIG. 3, system 400, FIG. 4, system 500, FIG. 5, etc.) for generating multiple AI models, where each AI model simulates an industry design process. In block 920, process 900 further provides for fusing (e.g., using the multi-modal fusion component 740, FIGS. 7, 8), by the computing device, where the multiple AI models generate a best-fit proposed industry design process. In block 930, process 900 further provides for utilizing, by the computing device, a physics constraint model (e.g., physics-aware constraints component (or model), 830, FIG. 8) to determine whether the best-fit proposed industry design process is feasible. In block 940, process 900 further provides for displaying (e.g., on the display device 438, FIG. 4, etc.) a representation (e.g., output or display information 760, FIGS. 7, 8) of the best-fit proposed industry design process in response to determining that the best-fit proposed industry design process is feasible.

In one embodiment, process 900 may further include the feature that the high fidelity simulation is selectively used for one of: a magnetic field, fluid dynamics, or heat diffusion. The method may additionally include that the fusing includes aggregating information from different design scopes via concatenation, gating, pooling, averaging, or tensor-based approximation.

In one embodiment, process 900 may further include the feature that the physics constraint model introduces constraints including non-artificial intelligence constraints or non-machine learning constraints. The constraints including encoding constraints (e.g., encoding constraints 820, FIG. 8), fusion constraints (e.g., fusion constraints 840) and decoding constraints (e.g., decoding constraints 880).

In one embodiment, process 900 may additionally include the feature that the encoding constraints include: a reconstruction objective, a classification objective or a regression objective of physical quantities of inputs. In one embodiment, process 900 may further include the feature that the encoding constraints include: a reconstruction objective, a classification objective or a regression objective of a physical relationship among different physical quantities of inputs.

In one embodiment, process 900 may additionally include the feature that the fusion constraints include restricted fusion processes that satisfy a physical relationship or interaction among different inputs. In one embodiment, process 900 may still further include the feature that the fusion constraints include a reconstruction objective, classification objective or regression objective of physical relationships among a sub-group of inputs.

In one embodiment, process 900 may further include the feature that the decoding constraints include a classification objective or a regression objective of physical quantities of output. In one embodiment, process 900 may yet further include the feature that the decoding constraints include a reconstruction objective, a classification objective or a regression objective of a physical relationship among different physical quantities of output. In one embodiment, process 900 may still further include the feature that the physical relationship is a hypothesis. One example of such a hypothesis is Navier-Stokes existence and smoothness. Navier-Stokes equations are widely used for modeling the dynamics of fluids. Given some initial conditions, engineers utilize the hypothesis that smooth solutions to the Navier-Stokes equations exist, but none of the previous work rigidly validate such hypothesis.

In some embodiments, the features described above contribute to the advantage of DL-based surrogate models for multiple design scopes that are required in practical design tasks. The features further contribute to the advantage of representing multiple design scopes in a coherent representation for prediction. The features still further contribute to the advantage of combining ML-based fusion components and physics-aware fusion constraints and objectives.

One or more embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using multiple artificial intelligence models for generating a high fidelity simulation, the method comprising:
generating, by a computing device, multiple artificial intelligence models, each artificial intelligence model simulating an industry design process;
fusing, by the computing device, the multiple artificial intelligence models to generate a best-fit proposed industry design process;
utilizing, by the computing device, a physics constraint model to determine whether the best-fit proposed industry design process is feasible; and
displaying a representation of the best-fit proposed industry design process in response to determining that the best-fit proposed industry design process is feasible.

2. The method of claim 1, wherein the high fidelity simulation is selectively used for one of: a magnetic field, fluid dynamics, or heat diffusion, and the fusing comprises aggregating information from different design scopes via concatenation, gating, pooling, averaging, or tensor-based approximation.

3. The method of claim 1, wherein the physics constraint model introduces constraints including non-artificial intelligence constraints or non-machine learning constraints, and the constraints comprise encoding constraints, fusion constraints and decoding constraints.

4. The method of claim 3, wherein the encoding constraints comprise: a reconstruction objective, a classification objective or a regression objective of physical quantities of inputs.

5. The method of claim 3, wherein the encoding constraints comprise: a reconstruction objective, a classification objective or a regression objective of a physical relationship among different physical quantities of inputs.

6. The method of claim 3, wherein the fusion constraints comprise restricted fusion processes that satisfy a physical relationship or interaction among different inputs.

7. The method of claim 3, wherein the fusion constraints comprise a reconstruction objective, classification objective or regression objective of physical relationships among a sub-group of inputs.

8. The method of claim 3, wherein the decoding constraints comprise a classification objective or a regression objective of physical quantities of output.

9. The method of claim 3, wherein the decoding constraints comprise a reconstruction objective, a classification objective or a regression objective of a physical relationship among different physical quantities of output.

10. The method of claim 9, wherein the physical relationship is a hypothesis.

11. A computer program product for using multiple artificial intelligence models for generating a high fidelity simulation, the computer program product comprising a computer readable storage medium having program instructions embodied therewith, the program instructions executable by a processor to cause the processor to:
generate, by the processor, multiple artificial intelligence models, each artificial intelligence model simulating an industry design process;
fuse, by the processor, the multiple artificial intelligence models to generate a best-fit proposed industry design process;
utilize, by the processor, a physics constraint model to determine whether the best-fit proposed industry design process is feasible; and
display, by the processor, a representation of the best-fit proposed industry design process in response to determining that the best-fit proposed industry design process is feasible.

12. The computer program product of claim 11, wherein:
the high fidelity simulation is selectively used for one of: a magnetic field, fluid dynamics, or heat diffusion;
the fuse of the multiple artificial intelligence models comprises aggregating information from different design scopes via concatenation, gating, pooling, averaging, or tensor-based approximation;
the physics constraint model introduces constraints including non-artificial intelligence constraints or non-machine learning constraints; and
the constraints comprise encoding constraints, fusion constraints and decoding constraints.

13. The computer program product of claim 12, wherein the encoding constraints comprise a reconstruction objective, a classification objective or a regression objective: of physical quantities of inputs, or a physical relationship among different physical quantities of inputs.

14. The computer program product of claim 12, wherein the fusion constraints comprise restricted fusion processes that satisfy a physical relationship or interaction among different inputs, or a reconstruction objective, classification objective or regression objective of physical relationships among a sub-group of inputs.

15. The computer program product of claim 12, wherein the decoding constraints comprise a classification objective or a regression objective of: physical quantities of output, or a physical relationship among different physical quantities of output.

16. The computer program product of claim 15, wherein the physical relationship is a hypothesis.

17. An apparatus comprising:
a memory configured to store instructions; and
a processor configured to execute the instructions to:
generate multiple artificial intelligence models, each artificial intelligence model simulating an industry design process;
fuse the multiple artificial intelligence models to generate a best-fit proposed industry design process;
utilize a physics constraint model to determine whether the best-fit proposed industry design process is feasible; and
display a representation of the best-fit proposed industry design process in response to determining that the best-fit proposed industry design process is feasible.

18. The apparatus of claim 17, wherein:
the high fidelity simulation is selectively used for one of: a magnetic field, fluid dynamics, or heat diffusion;
the fuse of the multiple artificial intelligence models comprises aggregating information from different design scopes via concatenation, gating, pooling, averaging, or tensor-based approximation;
the physics constraint model introduces constraints including non-artificial intelligence constraints or non-machine learning constraints; and
the constraints comprise encoding constraints, fusion constraints and decoding constraints.

19. The apparatus of claim 18, wherein:
the encoding constraints comprise: a reconstruction objective, a classification objective or a regression objective: of physical quantities of inputs, or a physical relationship among different physical quantities of inputs; and
the fusion constraints comprise: restricted fusion processes that satisfy a physical relationship or interaction among different inputs, or a reconstruction objective, classification objective or regression objective of physical relationships among a sub-group of input.

20. The apparatus of claim 18, wherein:
the decoding constraints comprise a classification objective or a regression objective of: physical quantities of output, or a physical relationship among different physical quantities of output; and
the physical relationship is a hypothesis.
